(19) United States
(12) Patent Application Publication
(10) Pub. No.: US 2002/0163710 A1
(43) Pub. Date: Nov. 7, 2002

(54) Composite optical amplifier

(76) Inventor: Andrew Ellis, Ipswich (GB)

Correspondence Address: CORNING INCORPORATED, 11 OAK PARK, BEDFORD, MA, 01730, US

(21) Appl. No.: 10/121,417

(22) Filed: Apr. 12, 2002

(30) Foreign Application Priority Data
Apr. 12, 2001 (GB) 0109167.7

(51) Int. Cl. H01S 3/00

(52) U.S. Cl. 359/333

(57) ABSTRACT

An optical signal amplifier has a first optically-pumped amplifier for amplifying an optical signal passed therethrough, and a further optical amplifier coupled to the first amplifier for providing a gain to further amplify the optical signal after it has passed through the first amplifier.

The gain of the further optical amplifier is clamped to induce lasing to provide pump radiation to the first amplifier to amplify the optical signal, and the first optically-pumped amplifier comprises a Raman amplifier.

### BACKGROUND OF THE INVENTION

1. Field of the Invention

This invention is directed to a composite optical amplifier, and in particular, to a composite optical amplifier that includes an optically-pumped amplifier.

2. Description of the Related Art

The continuous growth of bandwidth requirements in optical-based communication systems has resulted in a large demand for systems able to operate outside the amplification band provided by erbium-doped fiber amplifiers. Erbium-doped fiber amplifiers effectively operate over a limited wavelength band. Depending on amplifier configuration and fiber composition, erbium-doped fiber can be used for amplification in a wavelength band extending from 1530 nm to 1620 nm, a total spectrum of approximately 10THz, although at least two different erbium-doped fiber amplification configurations would be required to cover this entire range. The 10THz operating spectrum limits the maximum transmission rate to about 400 Gb/s in current commercial systems.

Other rare earth-doped fiber amplifiers have been used for amplification outside the erbium wavelength band from 1530 nm to 1620 nm. These other rare earth-doped amplifiers include Thulium-doped amplifiers operating from 1440 nm to 1510 nm, Praseodymium amplifiers operating from 1250 nm to 1310 nm and Neodymium amplifiers operating from 1310 nm to 1350 nm. Each of these rare earth-doped amplifiers exhibits very low efficiency as well as other technical problems associated with each particular kind of dopant when compared to erbium-doped amplifiers.

Rare earth-doped amplification systems cover the available transmission window of older silica fiber. However, this transmission window has been expanded with the development of new fibers. In many new fibers, where the OH absorption around 1400 nm has been greatly reduced, there is a potential for optical amplifier configurations which can amplify between an entire optical operating range from 1100 nm to 1700 nm.

Rare earth-doped fiber amplifiers, including erbium-doped fiber amplifiers, also have a significant drawback with respect to spacing, or the number of amplifiers required for a given span. Transmission distances ranging from about 100-200 km for a single span system to about 10,000 km for long submarine systems are possible depending on the signal loss between the erbium-doped amplifiers utilized in the system. Typical long submarine systems have span lengths of about 25-50 km, while typical terrestrial systems have span lengths of about 80-120 km with up to six spans. Both submarine systems and terrestrial systems require a significant number of erbium-doped amplifiers, or other rare earth-doped amplifiers, thereby adding significant cost to the system.

Two amplifier configurations have been used to amplify wavelength band ranges greater than can be amplified with singular rare earth-doped amplifiers. The first of these is the Raman fiber amplifier which converts laser radiation from a pump laser into amplified signals in another wavelength range through stimulated Raman scattering. More specifically, Raman scattering operates on the principle of Stokes light generation, which is downshifted from the optical pump frequency by an energy determined by vibrational oscillation modes in the atomic structure of the fiber with a transfer of energy to the signal laser, which is at a lower photon energy or longer wavelength than the pump laser. In other words, Raman gain results from the interaction of intense light with optical phonons in the glass,. and the Raman effect leads to a transfer of power from one optical beam to the signal beam. During a Raman gain, the signal is downshifted in frequency and upshifted in wavelength by an amount determined by the vibrational modes of the glass or the medium.

In operation, a pump laser is used to conduct pump radiation through a Raman medium. Signal radiation, which propagates through the Raman medium, will be amplified by stimulated Raman scattering, whereby a pump photon is stimulated to emit an optical phonon and also a photon at the same energy and phase as the signal photon. The wavelength range over which amplification occurs is referenced to the wavelength of the optical pump, and the bandwidth is determined by the phonon spectra of the Raman medium. A direct consequence of this is that amplification can be realised at any wavelength in an optical fiber by correct choice of the wavelength of the optical pump.

The gain of the Raman amplifier is determined by the Raman gain coefficient, the pump power, the fiber length and the effective area of the optical mode in the fiber. For high gain, a high gain coefficient, a high pump power and a long fiber length along with a small effective area are required. The Raman gain coefficient for silica fibers is shown in FIG. 1 where the frequency shift refers to the frequency difference between the Raman pump laser and the laser signal to be amplified. Notably, the gain extends over a large frequency range of up to 40THz with a broad peak centered at 13.2THz below the Raman pump frequency. This broad behavior is due to the amorphous structure of the silica glass and means that the Raman effect can be used to effect broad band amplification. The Raman gain depends on the composition of the fiber core and can be varied with different dopant types and concentrations within the fiber.

One of the problems generally associated with Raman amplifiers is the requirement of a relatively large pumping power. Raman amplifiers require a significantly higher optical pump power to achieve the same gain as compared with erbium-doped fiber amplifiers. In addition, a significant proportion of the optical pump power can be wasted and unused at the fiber output as a result of the inefficiency of Raman pumps. A significant advantage, however, of Raman amplifiers is the low noise figure associated therewith. More specifically, noise figures close to the quantum limit of 3 dB are possible with Raman amplifiers.

It is known to use Raman fiber amplifiers in conjunction with erbium-doped fiber amplifiers in transmission systems. The use of Raman fiber amplifiers in conjunction with erbium-doped fiber amplifiers increases the span length between amplifiers and/or permits an upgrade in the link from one bit rate to a higher bit rate. However, while the utilization of distributed Raman amplification in conjunction with erbium-doped fiber amplifiers alleviates the need for high Raman gain, the utility of such configurations are limited to the effective erbium window, or to other rare earth windows.

Semiconductor optical amplifiers can also be used to provide gain over respective 50 nm windows within the entire operating transmission window of around 1100 nm to 1670 nm. For example, semiconductor optical amplifier components based on semiconductors of the general formula GaₓIn₁₋ₓ As_{y} P_{1-y} can provide gain within the range of 1100 nm to 1670 nm depending on the relative concentration of the constituent elements.

Optical amplification, including amplification affected by a semiconductor. optical amplifier, relies on the known physical mechanisms of population inversion and stimulated emission. More specifically, amplification of an optical signal depends on the stimulated transition of an optical medium from an inverted, excited state to a lower, less excited state. Prior to the actual amplification of the optical signal, a population inversion occurs, i.e. more upper excited states exist than lower states. This population inversion is effected by appropriately energizing the system. In semiconductor optical amplifiers, an excited state is a state in which there exists an electron in the conduction band and a concomitant hole in the valence band. A transition from such an excited state to a lower state in which neither an electron nor a hole exist, results in the creation of a photon through stimulated emission. The population inversion is depleted every time an optical signal passes through the amplifier and is amplified. The population inversion is then reestablished over some finite period of time. As a result, the gain of the amplifier will be reduced for some given period of time following the passage of any optical signal through the amplifier. This recovery time period is typically denoted as the “gain-recovery time” of the amplifier.

In contrast to erbium-doped amplifiers, or other rare earth-doped amplifiers, semiconductor optical amplifiers are smaller, consume less power and can be formed in an array more easily. Accordingly, semiconductor optical amplifiers are important in applications such as loss compensation for optical switches used in multi-channel optical transmission systems or optical switchboard systems. In contrast to Raman fiber amplifiers, semiconductor optical amplifiers are electrically pumped, and as such provide very efficient gain.

Two major drawbacks are associated with semiconductor optical amplifiers. The first drawback is that the noise figure associated with semiconductor optical amplifiers is significantly high. While all amplifiers degrade the signal-to-noise ratio of the amplified signal because of amplified spontaneous emission that is added to the signal during amplification, the noise figure associated with semiconductor optical amplifiers is problematic. More specifically, the best achievable intrinsic noise figure for semiconductor optical amplifiers is around 4 dB for devices based on multiple quantum well structures, and around 5 dB for devices based on bulk guiding structures. Further, since the optical mode field diameter is very small in semiconductor optical amplifiers with respect to optical fibers, the coupling loss between the two is poor (generally 2 to 3 dB). As a result, the best achievable noise figures associated with packaged (ie fiber to fiber) semi-conductor optical amplifiers are typically somewhere between 6 to 8 dB, depending on the device structure and the coupling configuration.

The second problem associated with semiconductor optical amplifiers is signal cross-talk resulting from cross-gain modulation. Signal cross-talk arises because the saturation output power of the semiconductor optical amplifier is lower than that of fiber based amplifiers, and because the gain recovery time is on the same time scale as the data repetition rate. Thus, a semiconductor optical amplifier amplifying multiple signals with a combined input power greater than or close to the input saturation power will superimpose cross-talk caused by gain modulation between the relative channels.

EP 0717478 describes an optical amplifier made up of two rare earth-doped fiber amplifiers placed either side of a gain clamped semiconductor optical amplifier. The semiconductor optical amplifier is brought to stimulated emission conditions and acts as a pump radiation source for the two fiber amplifiers. Hence, separate pump lasers and associated couplers are not required for the two fiber amplifiers, while an optical signal within the gain profiles of the fiber amplifiers and semiconductor optical amplifier will be subject to three stages of amplification. However, the amplifier does have a number of disadvantages. For example, the composite amplifier will have a complex gain profile requiring advanced gain flattening filters; the wavelength band of operation of the composite amplifier is limited to the gain band of the fiber amplifiers; and as all the components of the composite amplifier need to be matched to ensure performance, the amplifier can only be installed in existing networks as a modular gain block.

It is an object to provide an improved optical signal amplifier providing greater flexibility for use over a wide wavelength band and capable of implementation in existing networks with minimal additional hardware.

### BRIEF SUMMARY OF THE INVENTION

According to a first aspect of the present invention, there is provided an optical signal amplifier comprising:

(i) a first optically-pumped amplifier for amplifying an optical signal passed therethrough; and

(ii) a further optical amplifier coupled to said first amplifier for providing gain to further amplify said optical signal after it has passed through said first amplifier, said gain of said further optical amplifier being clamped to induce lasing to provide pump radiation to said first amplifier to amplify said optical signal; wherein said first optically-pumped amplifier comprises a Raman amplifier.

By clamping the gain of the further optical amplifier appropriately, lasing may be induced at a frequency suitable for providing Raman pump power to the first optically-pumped amplifier while providing residual gain at longer wavelengths for the amplification of the optical signal. As Raman gain can be obtained at any wavelength, the composite Raman amplifier can be used to amplify any appropriate wavelength by suitable design of the gain clamped further optical amplifier. As the gain profile for Raman amplification is typically relatively flat, the Raman amplifier will not adversely affect the gain profile of the composite amplifier, and depending on the gain profile of the further optical amplifier, the gain profile of the composite amplifier should be simple, requiring little or no gain flattening. Since any fiber can act as a Raman amplifier, the transmission line itself can be part of the composite Raman amplifier, so the amplifier can conveniently be integrated into existing networks with minimal additional hardware, providing associated noise and size advantages. Furthermore, if the gain clamped optical amplifier has a carrier lifetime which falls substantially within the data spectrum, then it will demonstrate reduced patterning and increased saturation output power over its gain bandwidth compared with an unclamped amplifier, thereby reducing signal cross-talk resulting from cross-gain modulation.

Preferably, the further optical amplifier comprises a semiconductor optical amplifier. In this way, the composite optical amplifier makes use of the low noise figure typically associated with Raman amplifiers and the significant gain typically associated with semiconductor optical amplifiers to provide a relatively large gain in optical signal strength together with a substantially low noise figure.

Suitably, the gain of the further optical amplifier is clamped by means of a wavelength selective reflector on at least one side, which is partially reflective at the pump wavelength and substantially transparent at all other wavelengths within the further optical amplifier gain bandwidth. Preferably, the wavelength selective reflector comprises a grating. Alternatively, the further optical amplifier may be coupled to a circulator and a filter in a ring laser configuration to induce propagation of pump radiation through the optical amplifier in the opposite direction to that of the signal.

Suitably, the pump radiation propagates in the opposite direction to the signal through the first amplifier.

In a preferred embodiment, the optical signal amplifier further comprises:

(i) a first wavelength division multiplexer that divides said pump radiation from the optical signal amplified by said first optically-pumped amplifier; and

(ii) a second wavelength division multiplexer that combines said pump radiation with said optical signal amplified by said first optically-pumped amplifier, said second wavelength division multiplexer being in optical communication with said first wavelength division multiplexer;

wherein an optical isolator is positioned between said first and second wavelength division multiplexers.

According to a second aspect, there is provided an optical communications system comprising:

(i) an optical signal transmitter;

(ii) an optical signal amplifier as described above coupled to said optical signal transmitter for amplifying an optical signal generated by said optical signal transmitter; and

(iii) an optical signal receiver coupled to said optical signal amplifier for receiving the amplified optical signal.

According to a third aspect, there is provided a method for amplifying an optical signal, the method comprising the steps of:

(i) providing a Raman gain medium;

(ii) conducting at least one optical signal through said Raman gain medium;

(iii) providing a further optical amplifier having a particular gain;

(iv) amplifying said optical signal after it has passed through said Raman gain medium by means of said further optical amplifier; and

(v) clamping said gain of said further optical amplifier to induce lasing to provide pump radiation to said Raman gain medium to amplify said optical signal.

Preferably, the gain peak of the further optical amplifier occurs at a longer wavelength than the pump wavelength.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that both the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification. The drawings illustrate one or more embodiment(s) of the invention, and together with the description serve to explain the principles and operation of the invention.

### BRIEF DESCRIPTION OF THE DRAWINGS

In order that the invention may be more fully understood, embodiments thereof will now be described by way of example only, reference being made to the accompanying drawings in which:

FIG. 1 is a graph showing of the Raman gain coefficient for silica fibers;

FIG. 2 is a schematic view of a fiber optic communication system employing a composite optical amplifier embodying the present invention, including a Raman amplifier and a gain clamped semiconductor optical amplifier;

FIG. 3 is a diagram of gain versus amplified output power of the semiconductor optical amplifier of FIG. 2;

FIG. 4 is a diagram illustrating spectral performance of a semiconductor optical amplifier with and without gain clamping;

FIG. 5 is a diagram of the gain/noise spectra of the optical amplifier of FIG. 2;

FIG. 6 is a schematic view of a fiber optic communication system employing a plurality of composite optical amplifiers of the present invention; and

FIG. 7 is a schematic view of a fiber optic communication system according to the invention employing a ring laser configuration.

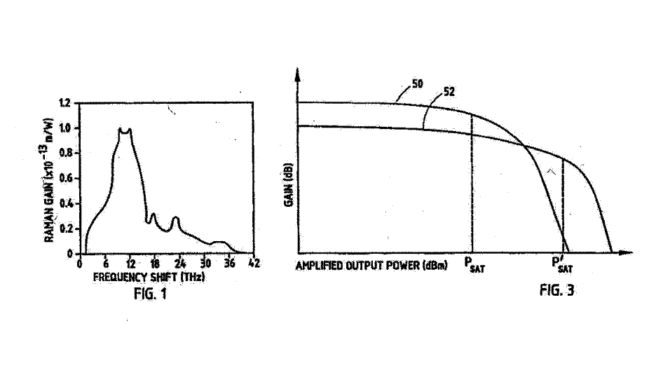

### DETAILED DESCRIPTION OF THE INVENTION

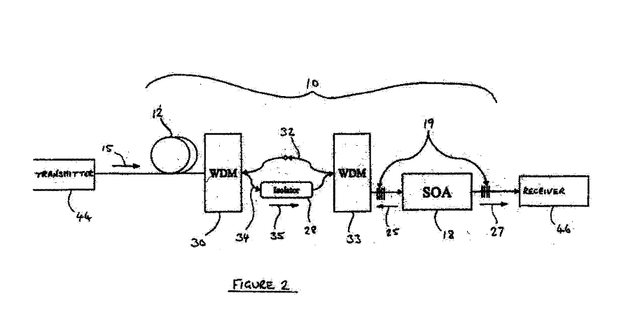

A fiber optic communication system according to one aspect of the present invention is shown in FIG. 2. The communication system employs a composite optical amplifier 10 which comprises a transmission fiber 12 for receiving an optical signal from a transmitter 44 travelling in a direction indicated by arrow 15. The transmission fiber 12 will behave as a Raman optical amplifier and amplify the optical signal when pumped with radiation of appropriate wavelength. The composite optical amplifier 10 also comprises a semiconductor optical amplifier 18 having fiber gratings 19 positioned within the optical waveguides to act as wavelength selective reflectors on either side to induce lasing and clamp the gain of the semiconductor optical amplifier. The gratings 19 are partially reflective at a wavelength towards the short side of the semiconductor optical amplifier gain bandwidth, having a value around 1400 nm in the illustrated example, and transparent at all other wavelengths within the semiconductor optical amplifier gain bandwidth.

In the illustrated example, the gain clamped semiconductor optical amplifier is coupled to the transmission fiber 12 via an isolation circuit comprising two optical pathways 32, 34 extending between first and second wavelength division multiplexers 30, 33, an optical isolator 28 being located along one of the optical pathways 34. The first and second wavelength division multiplexers 30, 33 serve as couplers to separate the optical signal and the pump radiation along optical pathways 34 and 32 respectively, though in practice any coupler capable of dividing and combining signals of varying wavelengths may be used. The optical isolator 28 is configured to allow passage of the optical signal therethrough in the direction of arrow 35 while preventing an amplified spontaneous emission at the signal wavelength generated within the semiconductor optical amplifier 18 from propagating in a backward direction with respect to arrow 35 through the transmission fiber 12. An optical isolator circuit may be unnecessary in certain systems where the effects on the Raman optical amplifier (transmission fiber 12) from the backward propagating amplified spontaneous emission generated within semiconductor optical amplifier 18 may be minimal. In such case, the output of Raman amplifier 12 could be coupled directly to the gain clamped semiconductor optical amplifier 18. The gain clamped semiconductor optical amplifier 18 is in turn coupled to a receiver 46 for receiving the optical signal after being amplified by composite amplifier 10.

In operation, the gain clamped semiconductor optical amplifier lases at 1400 nm due to the presence of the gratings 19. Some of the ‘pump’ radiation so generated passes in the direction of arrow 25 through the partially reflective grating 19 to the second wavelength division multiplexer 33, which directs it along optical pathway 32. When it reaches the first wavelength division multiplexer 30, the pump radiation is coupled to the transmission fiber 12, through which it propagates in the opposite direction to that of the optical signal. The optical signal transmitted from the transmitter 44 has a wavelength around 1430 nm in the illustrated example, which is close to the gain peak of the semiconductor optical amplifier 18 and longer than the wavelength of the pump radiation. The pump radiation amplifies the optical signal as it propagates through the transmission fiber 12, resulting in a first amplified signal. Such counter propagating pump radiation with respect to the signal has the advantage of minimising the transfer of pump noise to the signal.

When the first amplified optical signal reaches the first wavelength division multiplexer 30, it is directed along optical pathway 34, via the optical isolator 28, to the second wavelength division multiplexer 33, which serves to couple the first amplified signal to the gain clamped semiconductor optical amplifier. The first amplified signal passes through the grating 19 to the semiconductor optical amplifier 18, which further amplifies the signal. The resulting twice-amplified signal leaves semiconductor optical amplifier 18 in a direction indicated by arrow 27 and is received by the receiver 46.

The first stage of the composite optical amplifier is the transmission fiber 12 acting as a Raman optical amplifier 12. Only a modest gain is required from the Raman optical amplifier 12 because the amplified signal is later re-amplified by the semiconductor optical amplifier 18. The relatively low gain required from the Raman optical amplifier 12 relaxes the constraints and requirements of a high pump power that would be required to obtain a high gain from the Raman amplifier 12. In the present example, a gain from Raman optical amplifier 12 within the range of about 3 dB to about 23 dB would be satisfactory, however, a gain of between about 12 dB to about 20 dB is preferred.

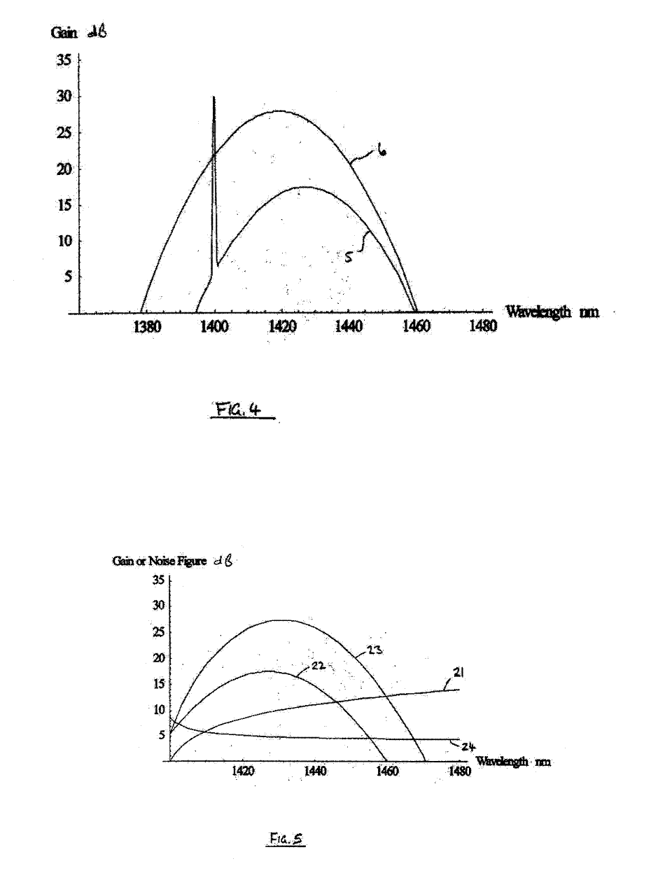

Gain clamping the semiconductor optical amplifier to induce lasing at a wavelength on the edge of the gain spectrum enhances the output saturation power of semiconductor optical amplifier 12. This lasing reduces the carrier lifetime within semiconductor optical amplifier 18 and thus increases the saturation output power thereof, which is inversely proportional to the carrier lifetime. In other words, the holding light maintains the separation of the quasi-Fermi levels and enhances the gain recovery rate or gain-recovery time of the amplifier, which is the result of a decrease in the effective carrier lifetime. Gain clamping the semiconductor optical amplifier results in a gain curve as shown in FIG. 3. As illustrated, a small signal gain from the gain clamped amplifier, illustrated as line 52, is clamped to a fairly consistent value, though reduced over much of its useful bandwidth from that of the free running (ie unclamped) gain, illustrated as line 50, resulting in a shift of the power saturation point. As illustrated, the power saturation point is the position along the gain curve that the gain is reduced by 3 dB with respect to the small signal gain value. The lasing wavelength must lie on the edge of the semiconductor optical amplifier gain spectrum in order to keep the gain compression at a minimum.

FIG. 4 shows how gain clamping the semiconductor optical amplifier at the Raman pump (lasing) wavelength may provide residual gain at longer wavelengths for the amplification of the optical signals (see curve 5), such residual gain being lower than would otherwise be available from an unclamped optical amplifier (shown by curve 6). As the degree of reflection at the lasing wavelength provided by the gratings is increased, the small signal gain provided by the optical amplifier decreases (not shown).

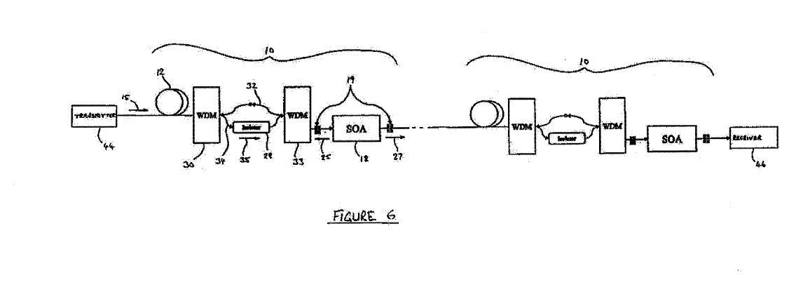

FIG. 5 shows the gain spectra of the Raman amplifier (curve 21), the semiconductor optical amplifier (curve 22) and the net gain of the composite optical signal amplifier (curve 23), together with the net noise figure of the composite optical signal amplifier (curve 24). With the gain clamped at around 6 dB at the pump wavelength (1400 nm), the semiconductor optical amplifier carrier density and characteristic peak wavelength defines the gain characteristic. An unclamped gain peak wavelength of 1420 nm results in a residual peak signal gain in the gain clamped semiconductor optical amplifier (curve 22) of around 17 dB at 1430 nm. Adding the Raman gain with a wavelength shift of only 20 to 50 nm sacrifices around 5 dB of peak Raman gain. However, in excess of 20 dB net gain over a considerable bandwidth is achieved from the composite amplifier (curve 23). Furthermore, the noise figure of a two-stage amplifier (in linear units) is defined as:

$${F}_{tot} = {F}_{1} + \frac{{F}_{2} - 1}{{G}_{1}} ,$$

wherein Fₜₒₜ is the noise figure of the composite amplifier, F₁ and F₂ are the individual noise figures of the first and second stage amplifiers, respectively, and G₁ is the gain of the first stage. Hence, the noise figure (curve 24) is dominated by the Raman stage from around 1430 nm. From FIG. 5 it can be seen that it is possible to achieve a small signal gain in excess of 20 dB and a noise figure below 5 dB using the composite amplifier within a wavelength window from around 1420 nm to around 1450 nm. In optically amplified systems, and particularly systems in which a first amplifier is a distributed Raman amplifier (where the Raman amplifying fiber is the transmission fiber), one needs to define a location at which to measure the noise figure of the first amplifier. In these circumstances, it is convenient to measure the noise figure at the input of the second amplifier, in which case the first amplifier contributes to an effective reduction in the logarithmic noise figure of the second amplifier.

An advantage of the composite optical amplifier 10 is that it provides a noise figure which is dictated by the low noise figure of the Raman optical amplifier 12. This is because the noise generated by an amplifier is a function of the ratio of the amount of amplification provided by the amplifier to the non-coherent spontaneous emission generated by the amplifier. In a two stage amplifier the spontaneous emission generated by the second stage is very small with respect to the amplified spontaneous emission incident from the first stage, and adds little to the overall noise figure. As a result, in a two stage amplifier, when the noise figure of the first stage is low the total noise figure is low, even if the second stage amplifier has a noise figure considerably greater than the first stage. In the present example, a typical noise figure from Raman optical amplifier 12 of no greater than about 4 dB is obtainable (and assumed for the purposes of these calculations). Further, a noise figure from semiconductor optical amplifier 18 of no greater than about 8 dB is obtainable. Therefore, composite optical amplifier 10 provides a noise figure of no greater than 4.9 dB.

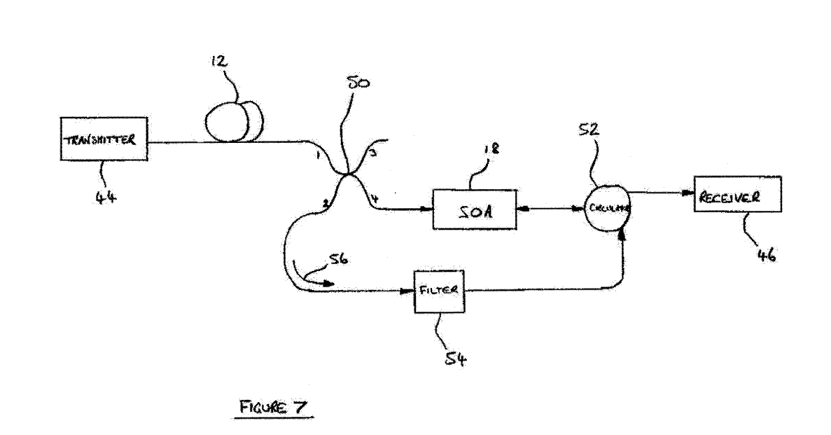

As shown in FIG. 6, the communications system may also include a plurality of spaced apart series coupled composite optical amplifiers 10. Each composite optical amplifier 10 includes a Raman fiber amplifier 12 in paired relationship with a gain clamped semiconductor optical amplifier 18. These composite optical amplifiers 10 are placed in optical communication and in series with one another between transmitter 44 and receiver 46, with a spacing of about 80-120 km with respect to terrestrial applications, and a spacing of about 25-50 km with respect to submarine applications.

FIG. 7 shows an alternative embodiment of the composite optical amplifier. In this embodiment, the transmission fiber 12 is coupled to the semiconductor optical amplifier 18 by means of a 4-way coupler 50 having four ports 1, 2, 3, 4 (though a 3 -way coupler could be used instead since port 3 of the 4-way coupler is redundant in this embodiment). The semiconductor optical amplifier 18 is in turn coupled to the bi-directional port of a circulator 52, the output port of which is coupled to the receiver 46. Port 2 of the coupler 50 is coupled to the input port of the circulator 52 via an optical filter 54. The optical filter 54 allows transmission of light only at the desired Raman pump wavelength, all other wavelengths being prevented from passing. The 4-way coupler 50 is designed to have a coupling efficiency which distributes a certain proportion of input radiation at a port to a first opposite (output) port, with the remaining proportion of input radiation passing to the second opposite port. It will be apparent that this coupling efficiency may be optimised to provide the desired characteristics of the composite optical amplifier. Alternatively, the coupler 50 could be a wavelength-dependent coupler to manage appropriate flows of pump and signal radiation as described below, in which case the filter 54 may not be required.

Instead of using wavelength selective reflectors on either side of the optical amplifier as described above with reference to FIG. 2, this embodiment employs a ring laser circuit to induce lasing within the semiconductor optical amplifier 18. In operation, a proportion of the signal generated within the semiconductor optical amplifier is tapped by the coupler 50 and passed through the optical filter 54, which only allows transmission of radiation at 1400 nm. This filtered radiation is fed back to the semiconductor optical amplifier via the circulator 52. This ring laser circuit maintains circulation of radiation at 1400 nm in the direction of arrow 56 and induces lasing within the amplifier. The coupler 50 also transmits a proportion of this radiation as pump radiation into the transmission fiber 12, through which it propagates in the opposite direction to that of the optical signal. The optical signal transmitted from the transmitter 44 has a wavelength around 1440 nm, which is close to the gain peak of the semiconductor optical amplifier 18 and longer than the wavelength of the pump radiation. The pump radiation therefore amplifies the optical signal as it propagates through the transmission fiber 12, resulting in a first amplified signal.

The coupler 50 then transmits a proportion of the first amplified optical signal via port 4 to the semiconductor optical amplifier 18, the remaining proportion of the first amplified signal being transmitted to port 3 of the coupler 50 and lost. The semiconductor optical amplifier 18 further amplifies the received signal, and the resulting twice-amplified signal is directed to the receiver 46 by the circulator 52.

The composite optical amplifiers described herein are effective for amplifying optical signals through a continuous spectrum of wavelengths within the usable optical signal wavelength range. The composite optical amplifier removes the need for a high power pump such as that required for solely Raman amplification, while reducing the noise associated with solely semiconductor optical amplification. The composite optical amplifiers as described herein make use of the characteristics of gain clamped-optical amplifiers to simultaneously provide pump radiation for Raman amplification and to improve the saturation output power of the optical amplifier, thereby reducing harmful cross-talk modulation. Raman optical amplifiers referred to herein include the distributed Raman fiber amplifiers and the discrete Raman fiber amplifiers. Although the embodiments described use semiconductor optical amplifiers to provide pump radiation and second stage amplification, it will be apparent that other types of optical amplifiers, such as rare earth-doped fiber amplifiers, could equally be used.

It will be apparent to those skilled in the art that various modifications to the preferred embodiments of the invention as described herein can be made without departing from the spirit or scope of the invention as defined by the appended claims. Thus, it is intended that the present invention cover the modifications and variations of this invention provided they come within the scope of the appended claims and their equivalents.

What is claimed is:

1. An optical signal amplifier comprising:
(i) a first optically-pumped amplifier for amplifying an optical signal passed therethrough; and
(ii) a further optical amplifier coupled to said first amplifier for providing gain to further amplify said optical signal after it has passed through said first amplifier, said gain of said further optical amplifier being clamped to induce lasing to provide pump radiation to said first amplifier to amplify said optical signal; wherein said first optically-pumped amplifier comprises a Raman amplifier.

2. An optical signal amplifier according to claim 1, wherein said further optical amplifier comprises a rare earth-doped fiber amplifier.

3. An optical signal amplifier according to claim 1, wherein said further optical amplifier comprises a semiconductor optical amplifier.

4. An optical signal amplifier according to claim 1, wherein said gain of said further optical amplifier is clamped by means of a wavelength selective reflector on at least one side thereof.

5. An optical signal amplifier according to claim 4, wherein said wavelength selective reflector comprises a grating.

6. An optical signal amplifier according to claim 4, wherein said wavelength selective reflector, which is partially reflective at the pump wavelength, is substantially transparent at all other wavelengths within the further optical amplifier gain bandwidth.

7. An optical signal amplifier according to claim 1, wherein said further optical amplifier is coupled to a circulator and a filter in a ring laser configuration to induce propagation of pump radiation through said optical amplifier in the opposite direction to that of said optical signal.

8. An optical signal amplifier according to claim 1, wherein said pump radiation propagates in the opposite direction to said optical signal through said first amplifier.

9. An optical signal amplifier according to claim 1, wherein said first amplifier has a noise figure which is lower than that of said further optical amplifier.

10. An optical signal amplifier according to claim 9, wherein said first amplifier has an associated first noise figure within the range from 3 dB to about 5 dB.

11. An optical signal amplifier according to claim 10, wherein said further optical amplifier has an associated second noise figure within the range of from about 7 dB to about 10 dB.

12. An optical signal amplifier according to claim 11, wherein amplification of said optical signal produces a total noise figure of less than or equal to about 5 dB.

13. An optical signal amplifier according to claim 1, wherein the total gain is within the range of from about 20 dB to about 30 dB.

14. An optical signal amplifier according to claim 1, wherein said optical signal is at a particular wavelength, said optical signal amplifier further comprising an optical isolator for preventing any amplified spontaneous emission generated by said further optical amplifier at said wavelength of said optical signal from propagating into said first optically-pumped amplifier.

15. An optical signal amplifier according to claim 14, comprising:
(i) a first wavelength division multiplexer that divides said pump radiation from the optical signal amplified by said first optically-pumped amplifier; and
(ii) a second wavelength division multiplexer that combines said pump radiation with said optical signal amplified by said first optically-pumped amplifier, said second wavelength division multiplexer being in optical communication with said first wavelength division multiplexer;
wherein said optical isolator is positioned between said first and second wavelength division multiplexers.

16. An optical communications system comprising:
(i) an optical signal transmitter;
(ii) an optical signal amplifier according to claim 1 coupled to said optical signal transmitter for amplifying an optical signal generated by said optical signal transmitter; and
(iii) an optical signal receiver coupled to said optical signal amplifier for receiving the amplified optical signal.

17. A method for amplifying an optical signal, the method comprising the steps of:
(i) providing a Raman gain medium;
(ii) conducting at least one optical signal through said Raman gain medium;
(iii) providing a further optical amplifier having a particular gain;
(iv) amplifying said optical signal after it has passed through said Raman gain medium by means of said further optical amplifier; and
(v) clamping said gain of said further optical amplifier to induce lasing to provide pump radiation to said Raman gain medium to amplify said optical signal.

18. A method according to claim 17, wherein said pump radiation propagates in the opposite direction to said optical signal through said Raman gain medium.

19. A method according to claim 17, further comprising the steps of:
(i) dividing said pump radiation from said optical signal after amplification by said Raman gain medium;
(ii) recombining said pump radiation with said optical signal after amplification by said Raman gain medium; and
(iii) isolating the divided amplified signal to prevent any amplified spontaneous emission generated by said further optical amplifier at the wavelength of the optical signal from propagating into said Raman gain medium.
